(19) United States
(12) Patent Application Publication
(10) Pub. No.: US 2008/0009971 A1
(43) Pub. Date: Jan. 10, 2008

(54) WALKING ROBOT AND CONTROL METHOD THEREOF

(75) Inventors: Hyun kyu KIM, Seoul (KR); Kyung Shik Roh, Seongnam-si (KR); Woong Kwon, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/744,249

(22) Filed: May 4, 2007

(30) Foreign Application Priority Data
Jul. 5, 2006 (KR) 2006-63091

(51) Int. Cl. G06F 19/00; G05B 19/00

(52) U.S. Cl. 700/245; 901/1

(57) ABSTRACT

A walking robot includes legs, driving parts provided respectively at the legs for operating the legs, detecting parts provided respectively at the legs for detecting operating states of the legs, a walking pattern generating unit for generating a walking pattern by using predetermined control factors, and a stiffness adjusting unit for adjusting stiffness of the driving parts according to the operating states of the legs which operate according to the walking pattern. The walking robot is capable of generating a walking pattern according to a unique frequency thereof and adjusting stiffness of driving parts of the legs according to the generated walking pattern, to thereby increase an energy efficiency.

### CROSS-REFERENCE TO RELATED APPLICATIONS

This application claims priority under 35 U.S.C. §119(a) from Korean Patent Application No. 2006-0063091, filed on Jul. 5, 2006 in the Korean Intellectual Property Office, the entire disclosure of which is incorporated herein by reference.

### BACKGROUND OF THE INVENTION

1. Field of the Invention

The present general inventive concept relates to a walking robot, and more particularly to a walking robot and control method thereof, which can adjust stiffness of driving parts to operate legs according to walking states of the legs and generate a walking pattern to match with a unique frequency of the walking robot.

2. Description of the Related Art

In general, a robot is a machine which is programmed to move and perform certain tasks automatically. Robots have been widely used in industrial fields since the late 1960's. The robot in an early stage is an industrial robot, such as a manipulator, a feeding device or the like, for the purpose of realizing an auto control system in plants.

The most basic apparatus for driving a movable robot is a four-wheeled driving apparatus. Four-wheeled movable robots have an advantage in that they are able to run stably without falling. They cannot, however, be widely used in practical applications, because they are only able to move on a flat surface and are not able to traverse a non-flat area, such as a step, a doorsill, or other similar obstacles. In order to make up for the disadvantage of the four-wheeled movable robots, biped walking robots, quadruped walking robots or hexapod walking robots have been developed recently. The biped walking robots have an advantage in that they are able to move more fluently on a non-flat surface or a discontinuous surface such as a step, a ladder or the like than the quadruped or hexapod walking robots.

A conventional biped walking robot includes a skeletal frame to provide a pair of legs like human legs. When controlling the biped walking robot, if control factors such as a stride, a pace and a walking direction are set, walking patterns of two legs are generated according to the set control factors, and a trajectory is determined according to the walking patterns. In order for the two legs to follow the determined trajectory, current positions of joints of the legs are derived from an inverse equation of motion, and control values for driving parts mounted to the joints are calculated to move the joints to target positions.

Such a biped walking is achieved by a servo control. During the biped walking, it is detected whether the legs accurately follow the trajectory determined according to the walking patterns. When the legs deviate from the trajectory, a servo torque is regulated. In other words, by regulating the torque corresponding to the deviation in the control values transmitted to the driving parts, the legs are controlled to accurately follow the trajectory.

However, the conventional method of controlling the walking robot has a disadvantage in that power consumption is increased, because the trajectory is derived at every moment the robot is walking, an error between the trajectory and the actual position of each leg is calculated, and the driving parts of the legs are servo-controlled continuously to follow the trajectory.

Such a continuous control of the driving parts increases a unique frequency of the walking robot, and increases a difference with natural walking behaviors of a human being. So, the efficient walking cannot be achieved.

Further, since the walking pattern is generated by the stride and the pace, preset regardless of the unique frequency of the walking robot, the energy consumption is increased.

### SUMMARY OF THE INVENTION

The present general inventive concept provides a walking robot and a control method thereof capable of generating a walking pattern according to a unique frequency of the walking robot and adjusting stiffness of driving parts of legs according to the generated walking pattern, to thereby increase an energy efficiency.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a walking robot including legs, driving parts provided respectively at the legs to operate the legs, detecting parts provided respectively at the legs to detect operating states of the legs, a walking pattern generating unit to generate a walking pattern by using predetermined control factors, and a stiffness adjusting unit to adjust a stiffness of the driving parts according to the operating states of the legs which operate according to the walking pattern.

The stiffness adjusting unit can adjust the stiffness of the driving parts by using a displacement of a bottom of each of the legs and a displacement of an end of each of the legs on the basis of a center of gravity of the walking robot.

The stiffness adjusting unit can also generate a stiffness adjusting pattern for each of the legs by using the displacement of the bottom of each of the legs and the displacement of the end of each of the legs according to the walking pattern generated from the walking pattern generating unit.

The operating state of each of the legs can include a load-supporting step to support a weight of the walking robot, a taking-off step to take each of the legs off of a ground respectively, a swing step, and a landing step to return each of the legs to the ground respectively. The stiffness adjusting unit adjusts the stiffness of the driving parts respectively according to the load-supporting step, the taking-off step, the swing step and the landing step.

The stiffness adjusting unit can set the stiffness of the driving parts in the swing step and the landing step to be lower than the stiffness of the driving parts in the load-supporting step and the taking-off step.

The walking pattern generating unit can include a neural oscillator which has two modeled neurons and generates an oscillating pattern by interaction between the neurons. The neural oscillator receives data about the operating states of the legs from the detecting parts and generates a walking pattern matching with a unique frequency of the walking robot.

The stiffness adjusting unit can generate a stiffness adjusting pattern for each of the legs according to the walking pattern generated from the walking pattern generating unit, and adjusts the stiffness of each of the legs according to the stiffness adjusting pattern.

The foregoing and/or other aspects and utilities of the present general inventive concept are also achieved by providing a method of controlling a walking robot including legs and driving parts to operate the legs, the method can include generating a walking pattern by using predetermined control factors; adjusting stiffness of each of the legs according to operating states of the legs which operate according to the walking pattern; calculating a control value for each of the legs according to the walking pattern and the stiffness of each of the legs; and controlling the operation of the legs according to the control value.

The adjusting can include adjusting the stiffness of each of the legs by using a displacement of a bottom of each of the legs and a displacement of an end of each of the legs on the basis of a center of gravity of the walking robot.

The adjusting further can include generating a stiffness adjusting pattern for each of the legs by using the displacement of the bottom of each of the legs and the displacement of the end of each of the legs according to the walking pattern, and adjusting the stiffness of each of the legs by using the stiffness adjusting pattern.

The method further can include dividing the operating state of each of the legs into a load-supporting step to support a weight of the walking robot, a taking-off step to take each of the legs off of a ground respectively, a swing step, and a landing step to return each of the legs to the ground. The adjusting can include adjusting the stiffness of the driving parts respectively according to the load-supporting step, the taking-off step, the swing step and the landing step.

The adjusting further can include setting the stiffness of the driving parts in the swing step and the landing step to be lower than the stiffness of the driving parts in the load-supporting step and the taking-off step.

The method can also include providing a neural oscillator to generate the walking pattern, the neural oscillator having two modeled neurons and generating an oscillating pattern by interaction between the neurons; detecting the operating states of the legs; and transmitting data about the operating states of the legs to the neural oscillator. The generating includes generating the walking pattern to match with a unique frequency of the walking robot.

The adjusting can also include generating a stiffness adjusting pattern for each of the legs according to the walking pattern, and adjusting the stiffness of each of the legs according to the stiffness adjusting pattern.

The foregoing and/or other aspects and utilities of the present general inventive concept are also achieved by providing a stiffness control method of a walking robot including legs, the method including calculating a trajectory of each leg according to a walking pattern and a stiffness of the leg continuously using an x-axis and a z-axis of the trajectory and adjusting the stiffness of each leg using the trajectory.

Adjusting the stiffness of each leg can further include using a stiffness adjustment pattern that is in inverse proportion to a distance on the z-axis in consideration of a distance on the x-axis.

The foregoing and/or other aspects and utilities of the present general inventive concept are also achieved by providing a walking robot including legs, driving parts provided respectively at the legs to operate the legs, and a control unit to determine a trajectory and to compute a driving amount of the driving parts according to a unique frequency of the walking robot.

The control unit can also use a walking pattern and adjusts the stiffness of the driving parts to determine the trajectory.

The control unit further uses a calculation of an inverse equation of motion to determine the driving amount of the driving parts.

The foregoing and/or other aspects and utilities of the present general inventive concept are also achieved by providing a method of controlling a walking robot, the method including dividing a walking process of the robot into a plurality of steps, calculating an optimal stiffness at each step according to specifications of the robot, and applying the calculated optimal stiffness at each step of the robot.

The specifications of the robot can be determined by a tuning process.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating legs and driving parts of a walking robot in accordance with an embodiment of the present general inventive concept;

FIG. 2 is a control block diagram illustrating a walking robot in accordance with an embodiment of the present general inventive concept;

FIG. 3 is a schematic view illustrating a neural oscillator of an embodiment of a walking pattern generating unit;

FIG. 4 is a view illustrating operating states of legs during walking, which are divided for a stiffness adjustment;

FIG. 5 is a graph illustrating operating states of legs and a stiffness adjusting pattern according to walking patterns; and

FIG. 6 is a flow chart illustrating a control method of a walking robot according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

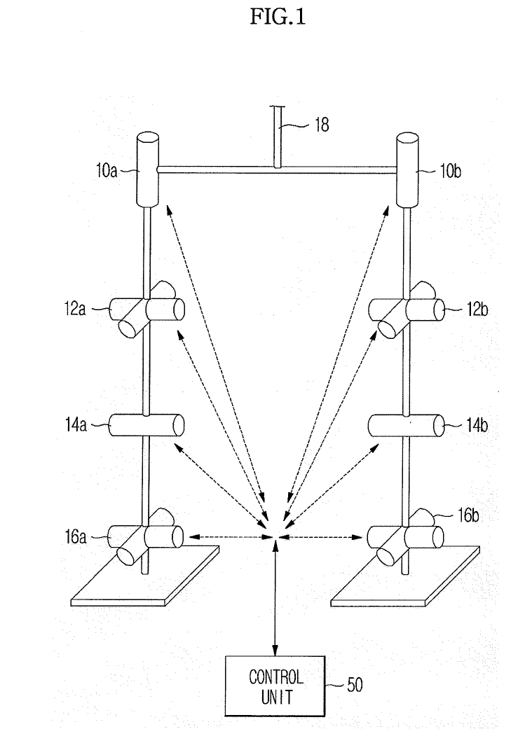

FIG. 1 is a schematic view illustrating legs and driving parts of a walking robot according to an embodiment of the present general inventive concept. As illustrated in FIG. 1, the legs and the driving parts of the walking robot are connected to an upper body part (not illustrated) through a waist joint 18. Driving parts 10a, 10b, 12a and 12b of femur joints move the legs in a pivot direction, an x-axis direction and a z-axis direction. For example, by operating the driving parts 10a and 10b of the femur joints for movement in the pivot direction, a walking direction of the walking robot can be controlled. In addition, by operating driving parts 14a and 14b of knee joints and driving parts 16a and 16b of ankle joints, positions of the legs are controlled.

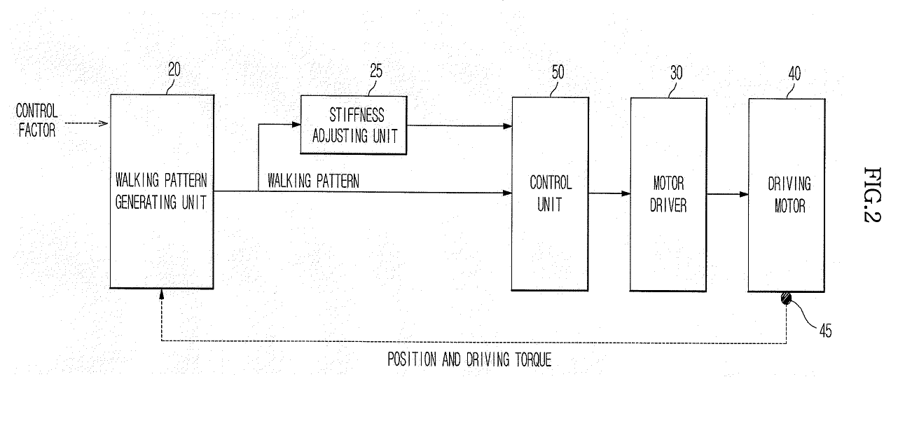

The driving parts of all joints of the legs are controlled by a control unit 50. FIG. 2 is a control block diagram of the walking robot according to an embodiment of the present general inventive concept. If control factors such as a stride, a pace, a walking direction and the like are set, a walking pattern generating unit 20 generates a walking pattern corresponding to the control factors, and outputs a phase signal having a constant frequency corresponding to the generated walking pattern. The walking pattern may not be generated only at an initial step of the walking but also in real time during the walking. An outputted phase signal illustrates operating states of the legs. For example, the outputted phase signal may indicate displacements of bottoms of the legs such as the displacements on the z-axis, or displacements of ends of the legs, or such as the displacements on the x-axis on the basis of a center of gravity of the walking robot. The walking pattern generating unit 20 may adjust the outputted phase signal according to the detected operating states of the driving parts, and generate the walking pattern according to the unique frequency of the walking robot, which will be described later.

The walking pattern generated from the walking pattern generating unit 20 is transmitted to a stiffness adjusting unit 25, and the stiffness adjusting unit 25 adjusts the stiffness according to the operating state of each leg which is driven according to the walking pattern. In order to precisely follow a trajectory, an error between a determined trajectory and an actual position of each leg must be minimized. For this reason, a strong force is applied to the driving parts (i.e., driving motors 40) to compensate for the error. Thus, a position of the driving motors 40 fluctuates along the trajectory with a high frequency. The same principle as providing a coil spring applies to having a high elasticity at the joints of the legs, based on the Hook's law, because a strong force is needed to deform the coil spring, and the joints of the legs are subjected to be located at a force-equilibrium position. Though the coil spring is deformed, the coil spring vibrates fast within an extremely narrow range. In general, such a state is called a high-stiffness state.

Different from the so-called high-stiffness state, a human being has natural walking behaviors such that the stiffness of two legs is adjusted appropriately for smooth and highly efficient walking. For example, if one leg is in a swing motion, the other leg should support a load (i.e., a weight) of a person. The leg supporting the load should maintain a high stiffness. If a foot is taken off the ground and a calf swings about the knee joint, the stiffness of a swinging leg may be lowered because the leg does not deviate so much from the trajectory in a state of equilibrium of gravity and inertia. By adjusting the stiffness of the legs according to the operating states of the legs, the servo-control amount of the driving motors 40 can be reduced, and the highly efficient walking can be performed.

The stiffness adjustment corresponding to the operating states of the legs may be performed in various ways. An example provides a quantized stiffness control method such that the walking process is divided into several (for example, four) operations, an optimal stiffness is calculated at each step through an experiment (the experiment is a kind of tuning process and varies according to the robot spec), and the calculated optimal stiffness is applied at each step.

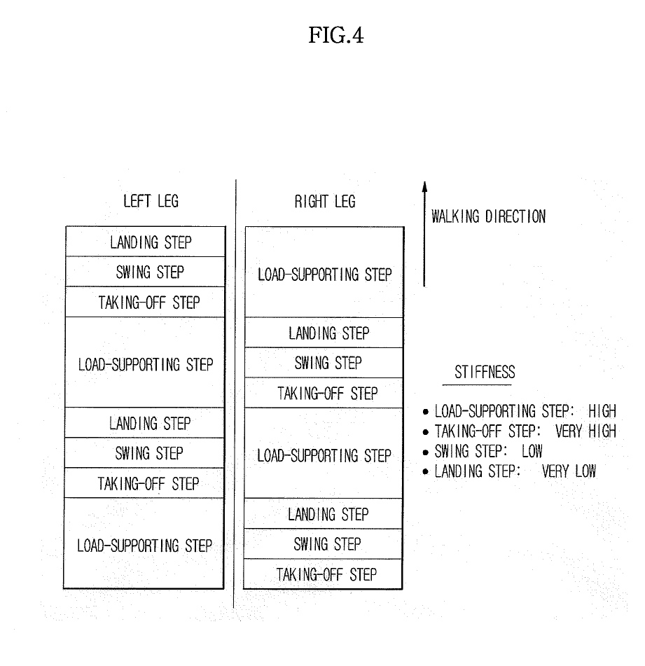

FIG. 4 is a view illustrating the operating states of the legs during walking operations, which are divided for the stiffness adjustment. As illustrated in FIG. 4, if a right leg is in a walking step, a left leg is in a load-supporting step. The walking step includes a taking-off step, a swing step and a landing step. In the load-supporting step, the leg should maintain high stiffness to support the load. In the taking-off step, the leg should maintain very high stiffness to follow the determined trajectory because an initial movement of the leg is fixed in the taking-off step. After that, since it does not matter if the leg swings or reaches the ground by gravity and inertia, the stiffness is maintained at low or very low levels in the swing step and the landing step. Preferably, the stiffness may be maintained at a low level in the swing step, and the stiffness may be maintained at a very low level in the landing step. The stiffness in the load-supporting step may be set equal to or higher than the stiffness in the taking-off step. On the other hand, the stiffness in the swing step may be set equal to or lower than the stiffness in the landing step.

Another example provides a stiffness control method such that the trajectory of each leg is calculated according to the walking patterns, and the stiffness of the legs is adjusted continuously by using the distance on the x-axis or z-axis of the trajectory. This control method can increase an energy efficiency, but has a complicated control process, compared with the aforementioned control method according to the operating states of the legs.

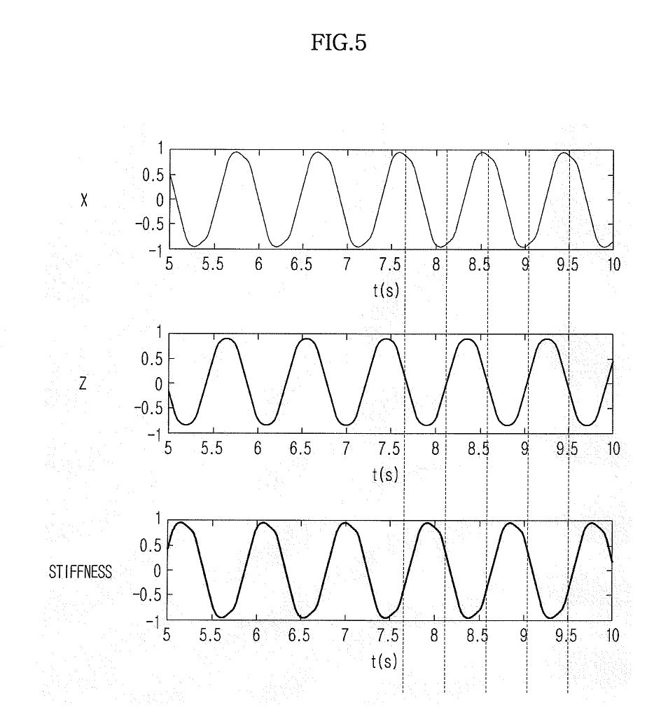

FIG. 5 is a graph illustrating a stiffness adjustment pattern with a lapse of time according to the control method wherein the stiffness of the legs is adjusted continuously by using a distance on the x-axis or the z-axis of the trajectory. The stiffness adjusting pattern illustrated in FIG. 5 has a characteristic of being in inverse proportion to the distance on the z-axis in consideration of the distance on the x-axis. Such a stiffness adjusting pattern is acquired through the experiment, and may be changed in many ways according to the specifications of the robot.

The control unit 50 receives the walking patterns and the adjusted stiffness from the stiffness adjusting unit 25, determines the trajectory, and computes a driving amount of the driving motors 40 of the joints by calculating an inverse equation of motion. According to the computed driving amount, the control unit 50 transmits a motor control signal to a motor driver 30. In response to the motor control signal from the control unit 50, the motor driver 30 operates the driving motors 40. Detecting parts 45 are provided respectively at the legs, and detect the operating states of the driving motors 40, such as a position, a driving torque and the like. The detecting parts 45 transmit the detected values to the walking pattern generating unit 20 to adjust the phase signal according to the walking patterns.

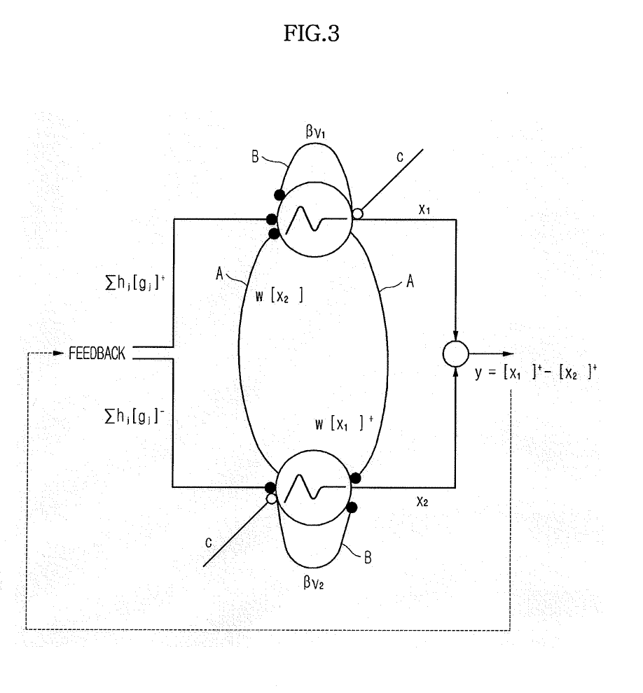

FIG. 3 is a schematic view illustrating a neural oscillator of an embodiment of the walking pattern generating unit. As illustrated in FIG. 3, the neural oscillator includes two modeled neurons. Two neurons are connected to each other by inhibitions A. Each neuron has an inhibition B. The neural oscillator generates the walking pattern (the oscillating pattern) matching with the unique frequency of the walking robot through the inhibitions A and B, which is called an “entrainment”. In order to generate a natural walking pattern similar to a real human walking pattern, it is necessary to maintain the unique frequency of the walking robot at a low level. By appropriately regulating the stiffness in walking by using the control method of the present general inventive concept, the unique frequency of the walking robot can be lowered, and the entrainment in the neural oscillator can be achieved, to thereby generate the smooth walking pattern and increase the energy efficiency. Since the detailed explanation of the neural oscillator is disclosed in “Neural control of rhythmic arm movements” (Neural Networks, M. Willianmson, vol. 11, no. 7-8, pp. 1379-1394, 1998), the description of the neural oscillator is omitted herein. By applying the neural oscillator to a walking control, the stiffness is adjusted appropriately and the walking pattern to match with the unique frequency of the natural walking behavior is generated.

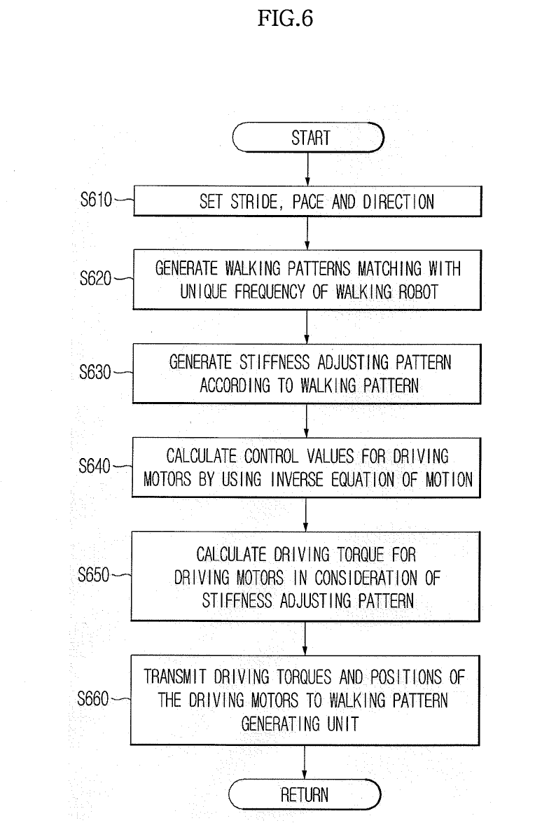

FIG. 6 is a flow chart illustrating a control method of the walking robot according to an embodiment of the present general inventive concept. First, control factors such as the stride, the pace, the walking direction and the like are set and inputted at operation S610. The walking pattern generating unit 20 receives the control factors and the feedback data of the operating states of the driving parts, and generates the walking patterns to match with the unique frequency of the walking robot at operation S620. The stiffness adjusting unit 25 generates the stiffness adjusting pattern according to the generated walking pattern at operation S630. The control unit 50 receives the walking pattern and the stiffness adjusting pattern, and calculates the control values for the driving motors of the joints by using the inverse equation of motion at operation S640. The motor driver 30 receives the control values, and calculates the driving torque for the driving motors 40 of the joints in consideration of the stiffness adjusting pattern at operation S650. The detecting parts 45 detect the operating states of the driving motors 40, such as the positions and the driving torques, and transmit the detected values to the walking pattern generating unit 20 at operation S660, so that the walking pattern generating unit 20 can generate the walking pattern to match with the unique frequency of the walking robot.

As apparent from the above description, the walking robot and control method thereof according to the embodiments of the present general inventive concept can achieve a smooth and highly-efficient walking robot. Since the walking pattern to match with the unique frequency of the walking robot can be generated, energy efficiency is increased.

Also, the unique frequency of the walking robot can be lowered by adjusting the stiffness of the driving parts during the walking operations.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A walking robot comprising:
legs;
driving parts provided respectively at the legs to operate the legs;
detecting parts provided respectively at the legs to detect operating states of the legs;
a walking pattern generating unit to generate a walking pattern by using predetermined control factors; and
a stiffness adjusting unit to adjust a stiffness of the driving parts according to the operating states of the legs which operate according to the walking pattern.

2. The walking robot according to claim 1, wherein the stiffness adjusting unit adjusts the stiffness of the driving parts by using a displacement of a bottom of each of the legs and a displacement of an end of each of the legs on the basis of a center of gravity of the walking robot.

3. The walking robot according to claim 2, wherein the stiffness adjusting unit generates a stiffness adjusting pattern for each of the legs by using the displacement of the bottom of each of the legs and the displacement of the end of each of the legs according to the walking pattern generated from the walking pattern generating unit.

4. The walking robot according to claim 1, wherein the operating state of each of the legs comprises:
a load-supporting step to support a weight of the walking robot, a taking-off step to take each of the legs off of the ground respectively, a swing step, and a landing step to return each of the legs to the ground, and
the stiffness adjusting unit to adjust the stiffness of the driving parts respectively according to the load-supporting step, the taking-off step, the swing step and the landing step.

5. The walking robot according to claim 4, wherein the stiffness adjusting unit sets the stiffness of the driving parts in the swing step and the landing step to be lower than the stiffness of the driving parts in the load-supporting step and the taking-off step.

6. The walking robot according to claim 1, wherein the walking pattern generating unit comprises a neural oscillator which has two modeled neurons and generates an oscillating pattern by interaction between the neurons, and
the neural oscillator receives data about the operating states of the legs from the detecting parts and generates a walking pattern matching with a unique frequency of the walking robot.

7. The walking robot according to claim 1, wherein the stiffness adjusting unit generates a stiffness adjusting pattern for each of the legs according to the walking pattern generated from the walking pattern generating unit, and adjusts the stiffness of each of the legs according to the stiffness adjusting pattern.

8. A method of controlling a walking robot including legs and driving parts to operate the legs, the method comprising:
generating a walking pattern by using predetermined control factors;
adjusting stiffness of each of the legs according to operating states of the legs which operate according to the walking pattern;
calculating a control value for each of the legs according to the walking pattern and the stiffness of each of the legs; and
controlling the operation of the legs according to the control value.

9. The method according to claim 8, wherein the adjusting includes:
adjusting the stiffness of each of the legs by using a displacement of a bottom of each of the legs and a displacement of an end of each of the legs on the basis of a center of gravity of the walking robot.

10. The method according to claim 9, wherein the adjusting further includes:
generating a stiffness adjusting pattern for each of the legs by using the displacement of the bottom of each of the legs and the displacement of the end of each of the legs according to the walking pattern; and
adjusting the stiffness of each of the legs by using the stiffness adjusting pattern.

11. The method according to claim 8, further comprising:
dividing the operating state of each of the legs into a load-supporting step to support a weight of the walking robot, a taking-off step to take each of the legs off the ground respectively, a swing step, and a landing step to return each of the legs to the ground respectively, and
adjusting the stiffness of the driving parts respectively according to the load-supporting step, the taking-off step, the swing step and the landing step.

12. The method according to claim 11, wherein the adjusting further includes:
setting the stiffness of the driving parts in the swing step and the landing step to be lower than the stiffness of the driving parts in the load-supporting step and the taking-off step.

13. The method according to claim 8, further comprising:
providing a neural oscillator to generate the walking pattern, the neural oscillator having two modeled neurons and generating an oscillating pattern by interaction between the neurons;
detecting the operating states of the legs;
transmitting data about the operating states of the legs to the neural oscillator; and
generating the walking pattern to match with a unique frequency of the walking robot.

14. The method according to claim 8, wherein the adjusting includes:
generating a stiffness adjusting pattern for each of the legs according to the walking pattern; and
adjusting the stiffness of each of the legs according to the stiffness adjusting pattern.
